(19) United States
(12) Patent Application Publication
(10) Pub. No.: US 2015/0323958 A1
(43) Pub. Date: Nov. 12, 2015

(54) CLOCK SKEW MANAGEMENT SYSTEMS, METHODS, AND RELATED COMPONENTS

(71) Applicant: QUALCOMM Incorporated, San Diego, CA (US)

(72) Inventor: Karim Arabi, San Diego, CA (US)

(73) Assignee: QUALCOMM Incorporated, San Diego, CA (US)

(21) Appl. No.: 14/273,061

(22) Filed: May 8, 2014

(51) Int. Cl. G06F 1/10

(52) U.S. Cl. CPC G06F 1/10

(57) ABSTRACT

Clock skew management systems are disclosed. Methods and related components are also disclosed. In an exemplary aspect, to offset the skew that may result across the tiers in the clock tree, a cross-tier clock balancing scheme makes use of automatic delay adjustment. In particular, a delay sensing circuit detects a difference in delay at comparable points in the clock tree between different tiers and instructs a programmable delay element to delay the clock signals on the faster of the two tiers. In a second exemplary aspect, a metal mesh is provided to all elements within the clock tree and acts as a signal aggregator that provides clock signals to the clocked elements substantially simultaneously.

### BACKGROUND

I. Field of the Disclosure

The technology of the disclosure relates generally to clock management in integrated circuits (ICs).

II. Background

Computing devices, and particularly mobile communication devices, have become common in current society. The prevalence of these computing devices is driven in part by the many functions that are now enabled on such devices. Demand for such functions increases processing capability requirements and generates a need for more complex circuits. While it is possible that some of this circuitry may function asynchronously, in many cases the circuitry requires (or at least benefits from) a common clock signal. This common clock signal and the clock sinks may be referred to and represented as a clock tree.

As the number of elements requiring a common clock signal increases, the physical distance between the clock source and a given clock sink may increase, requiring long conductors, which in turn leads to delay in arrival of the clock signal. Complicating matters is the fact that different sinks may be different distances from the clock source. The different distances mean that the clock signal will arrive at the sinks at different times. This difference is sometimes referred to as clock skew.

While the majority of clock skew comes from the different clock paths within the clock tree, some additional clock skew may arise from process variations between elements. Still further clock skew may result from clock uncertainty. Clock skew is of concern because it reduces the effective clock period available for computation. One solution to minimize clock skew is a H-format clock tree, which attempts to force each sink to be a same distance from the clock source. However, such an H-format clock tree imposes too many constraints during circuit design and layout. Accordingly, there is a need to provide improved clock management regimes in ICs.

### SUMMARY OF THE DISCLOSURE

Aspects disclosed in the detailed description include clock skew management systems. Methods and related components are also disclosed. In an exemplary aspect, the clock tree is divided into sub-regions or sub-units, with each sub-region or sub-unit including a programmable delay cell at or proximate to a root of the sub-unit. The programmable delay cell introduces delay into an arriving clock signal so that clock skew between different sub-units is uniform. The delay provided by the programmable delay cell is determined by a control input. A delay sense circuit may be used to help determine the control input.

In addition to helping control clock skew and reducing problems associated with undesired clock skew, various aspects of the present disclosure vary the position and inputs for the delay sense circuit allowing the circuit designer to select a solution which is optimal for the circuit being designed. One of the benefits of aspects of the present disclosure is the elimination of the need to use an H-format clock tree and/or allow use of other asymmetric clock tree layouts.

In this regard in one aspect, a clock tree is disclosed. The clock tree comprises a first clock branch of the clock tree, the first clock branch comprising a first single programmable delay cell configured to receive a clock signal and generate a first delay output comprised of a first delayed clock signal based on a first control input. The clock tree also comprises a second clock branch of the clock tree, the second clock branch comprising a second single programmable delay cell configured to generate a second delay output comprised of a second delayed clock signal based on a second control input. The clock tree is also comprised of a third clock branch of the clock tree, the third clock branch comprising a third single programmable delay cell configured to generate a third delay output comprised of a third delayed clock signal based on a third control input. The clock tree is also comprised of a first delay sense circuit comprising a first delay input coupled to the first delay output and a second delay input coupled to the second delay output, the first delay sense circuit configured to generate a first correction signal based on the difference in time arrival between the first delay output and the second delay output. The clock tree is also comprised of a second delay sense circuit comprising a third delay input coupled to the second delay output and an fourth delay input coupled to the third delay output, the second delay sense circuit configured to generate a second correction signal based on the difference in time arrival between the second delay output and the third delay output. The clock tree is also comprised of a global control unit configured to receive a first correction signal and the second correction signal and determine a global control input based on the correction signals, wherein the global control input determines the first control input, the second control input and the third control input.

In another aspect, a clock tree is disclosed. The clock tree comprises at least one first clock branch of the clock tree, the at least one first clock branch comprising a first phase detector and a first single programmable delay cell configured to receive a clock signal and generate a first delay output comprised of a first delayed clock signal based on a first control input, the first phase detector receiving the first delayed clock signal and a second delayed clock signal from at least one second clock branch and generate a first error signal. The clock tree also comprises at least one second clock branch of the clock tree, the at least one second clock branch comprising a second phase detector and a second single programmable delay cell configured to generate a second delay output comprised of a second delayed clock signal based on a second control input, the second phase detector receiving the second delayed clock signal and a third delayed clock signal from at least a third clock branch and generate a second error signal. The clock tree also comprises a global control unit configured to receive the first and second error signals and generate the first and second control inputs.

In another aspect, a clock tree is disclosed. The clock tree comprises at least one first clock branch of the clock tree, the at least one first clock branch comprising a first phase detector and a first single programmable delay cell configured to receive a clock signal and generate a first delay output comprised of a first delayed clock signal based on a first control input, the first phase detector receiving the first delayed clock signal and a global clock signal and generate a first error signal. The clock tree also comprises at least one second clock branch of the clock tree, the at least one second clock branch comprising a second phase detector and a second single programmable delay cell configured to generate a second delay output comprised of a second delayed clock signal based on a second control input, the second phase detector receiving the second delayed clock signal and the global clock signal and generate a second error signal. The clock tree is also comprised of a global control unit configured to receive the first and second error signals and generate the first and second control inputs.

In another aspect, a method of operating a clock tree within an IC is disclosed. The method comprises generating a clock signal at a root; directing the clock signal through a first clock branch of the clock tree, wherein the first clock branch is not an H-format clock branch; and directing the clock signal through a second clock branch of the clock tree. The method also comprises receiving delayed clock signals from the first clock branch and the second clock branch at a delay sense circuit; calculating at the delay sense circuit a difference in arrival times of the delayed clock signals from the first clock branch and the second clock branch; providing an indication of the difference in arrival times to a global control unit and generating at the global control unit a control input based on difference in arrival times of the delayed clock signal. The method also comprises providing the control input to the delay sense circuit and sending a correction signal to a first programmable delay cell in the first clock branch.

In this regard in one aspect, a non-H-format clock tree is disclosed. The non-H-format clock tree comprises at least one first clock branch of the non-H-format clock tree, the at least one first clock branch comprising a first single programmable delay cell configured to receive a clock signal and generate a first delay output comprised of a first delayed clock signal based on a first control input. The non-H-format clock tree is also comprised of at least one second clock branch of the non-H-format clock tree, the at least one second clock branch comprising a second single programmable delay cell configured to generate a second delay output comprised of a second delayed clock signal based on a second control input. The non-H-format clock tree also comprises a delay sense circuit comprising a first delay input coupled to the first delay output and a second delay input coupled to the second delay output, the delay sense circuit configured to generate a control input based on the difference in time arrival between the first delay input and the second delay output.

In another aspect, a clock tree is disclosed. The clock tree comprises a first clock branch of the clock tree, the first clock branch comprising a first single programmable delay cell configured to receive a clock signal and generate a first delay output comprised of a first delayed clock signal based on a first control signal. The clock tree also comprises a second clock branch of the clock tree, the second clock branch comprising a second single programmable delay cell configured to generate a second delay output comprised of a second delayed clock signal based on a second control signal. The clock tree is also comprised of a third clock branch of the clock tree, the at least one third clock branch comprising a third single programmable delay cell configured to generate a third delay output comprised of a third delayed clock signal based on a third control signal. The clock tree is also comprised of a first delay sense circuit configured to receive the first delay output and second delay output, the first delay sense circuit configured to generate the first control signal based on the difference in time arrival between the first delay output and the second delay output. The clock tree is also comprised of a second delay sense circuit configured to receive the second delay output and the third delay output, the second delay sense circuit configured to generate the second control signal based on the difference in time arrival between the second delay output and the third delay output.

In another aspect, a clock tree is disclosed. The clock tree comprises a first clock branch of the clock tree, the first clock branch comprising a first single programmable delay cell configured to receive a clock signal and generate a first delay output comprised of a first delayed clock signal based on a first control input. The clock tree also comprises a second clock branch of the clock tree, the second clock branch comprising a second single programmable delay cell configured to generate a second delay output comprised of a second delayed clock signal based on a second control input. The clock tree is also comprised of a first delay sense circuit comprising a first delay input coupled to the first delay output and a global clock signal, the delay sense circuit configured to generate the first control input based on the difference in time arrival between the first delay input and the global clock signal. The clock tree is also comprised of a second delay sense circuit configured to receive the second delay output and the global clock signal and generate the second control input based on the difference in time arrival between the second delay input and the global clock signal.

### BRIEF DESCRIPTION OF THE FIGURES

FIG. 1 is a simplified schematic of an exemplary clock tree with programmable delay cells associated with cells within the clock tree;

FIG. 2 is a simplified clock tree that illustrates sources of delay within a clock tree;

FIG. 3 illustrates a conventional H-format clock tree schematic;

FIG. 4 is a simplified schematic of a first aspect of a clock tree with shared delay sense circuits, programmable delay cells, and a global control unit;

FIG. 5 is a simplified schematic of a second aspect of a clock tree with shared phase detectors, programmable delay cells, and a global control unit;

FIG. 6 is simplified schematic of a third aspect of a clock tree with phase detectors, a global clock signal, programmable delay cells, and a global control unit;

FIG. 7 is a simplified schematic of a fourth aspect of a clock tree with a shared delay sense circuit and programmable delay cells without a global control unit;

FIG. 8 is a simplified schematic of a fifth aspect of a clock tree with a delay sense circuit that receives a global clock signal and programmable delay cells without a global control unit;

FIG. 9 is a simplified schematic of a delay sense circuit such as may be used with the aspects of FIGS. 4, 7, and 8;

FIG. 10 is an alternate exemplary delay sense circuit such as may be used with the clock tree of FIG. 4, 7, or 8;

FIGS. 11A-11C are simplified circuit diagrams for different aspects of programmable delay cells for use with clock trees; and

FIG. 12 is a block diagram of an exemplary processor-based system that can include the delay corrected clock trees of FIGS. 4-8.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include clock skew management systems. Methods and related components are also disclosed. In an exemplary aspect, the clock tree is divided into sub-regions or sub-units, with each sub-region or sub-unit including a programmable delay cell at a root of the sub-unit. The programmable delay cell introduces delay into an arriving clock signal so that clock skew between different sub-units is uniform. The delay provided by the programmable delay cell is determined by a control input. A delay sense circuit may be used to help determine the control input.

In addition to helping control clock skew and reducing problems associated with undesired clock skew, various aspects of the present disclosure vary the position and inputs for the delay sense circuit allowing the circuit designer to select a solution which is optimal for the circuit being designed. One of the benefits of aspects of the present disclosure is the elimination of the need to use an H-format clock tree and/or use other asymmetric clock tree layouts.

By adding the programmable delay element, the faster of the clock signals is slowed to match the clock signal on the slower branch. By matching the clock signals, the clock skew is minimized and the overall performance of the IC is improved because fewer cycles are misaligned. This arrangement helps compensate for process variations that may exist between different elements within the IC as well as smooth variations introduced by clock branches of different length. Such compensation and smoothing helps clocked elements within the circuit sample the correct portion of the data signal.

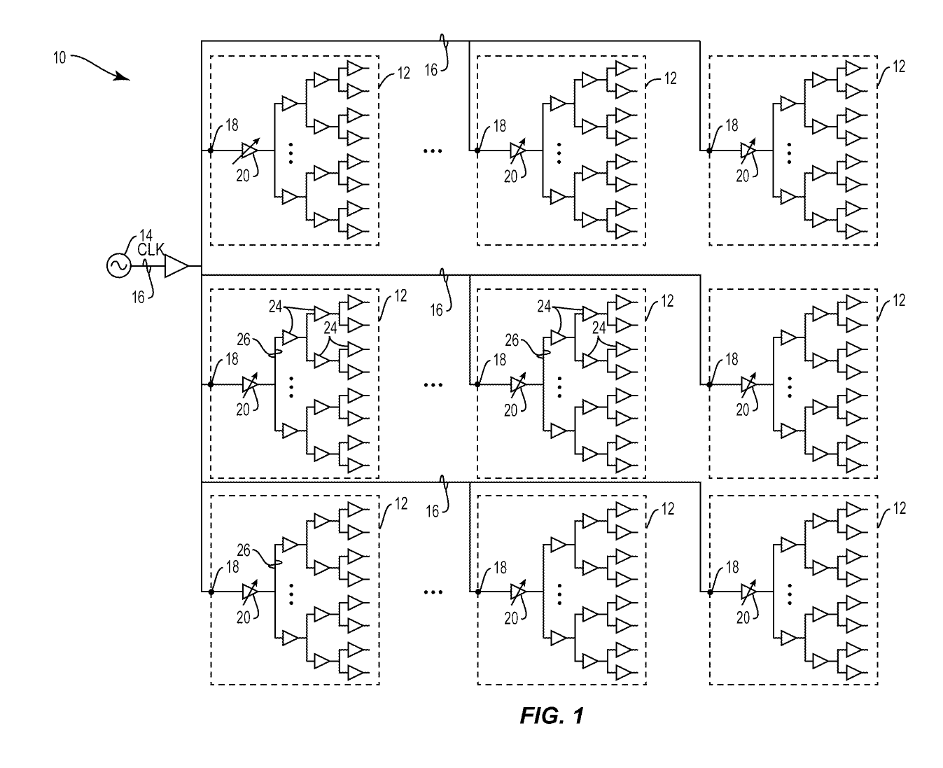

Before addressing particular aspects of the present disclosure, a generic clock tree 10 with sub-regions or sub-units 12 cells is described with reference to FIG. 1. In this regard, the clock tree 10 has a clock source 14 that generates a clock (CLK) signal 16 that is provided to each sub-unit 12. At arrival at a given sub-unit 12, the CLK signal 16 is considered at a root 18. Proximate the root 18, a programmable delay cell (PDC) 20 is positioned for each sub-unit 12. While not illustrated, additional programmable delay cells may be positioned at other locations within the sub-unit 12. While such additional programmable delay cells are possible, aspects of the present disclosure reduce the need for such additional programmable delay cells.

With continued reference to FIG. 1, each sub-unit 12 may have additional clocked elements 24 to which a delayed clock signal 26 is provided. Such additional clocked elements 24 may be flops or latches or other clocked elements as needed or desired to effectuate the functionality of the IC in which the clock tree 10 is located. It should be appreciated that each additional clocked element 24 may introduce further delay into the delayed clock signal 26 such that the further from the root 18 the delayed clock signal 26 is, the more delayed the signal.

It should be appreciated that FIG. 1 is a very simplified version of a clock tree with symmetrical splits on the branches and identical leaves. In reality, the paths (branches) to the various leaves of the clock tree may be of different length and/or have different numbers of clocked elements 24 between the root 18 and the particular clocked element 24. Thus, the delay between various elements of the clock tree 10 may vary. Furthermore, there may be process variations that arise between different clocked elements 24. Such process variations are sometimes referred to as a clock uncertainty factor (T_{clkUncertainty}).

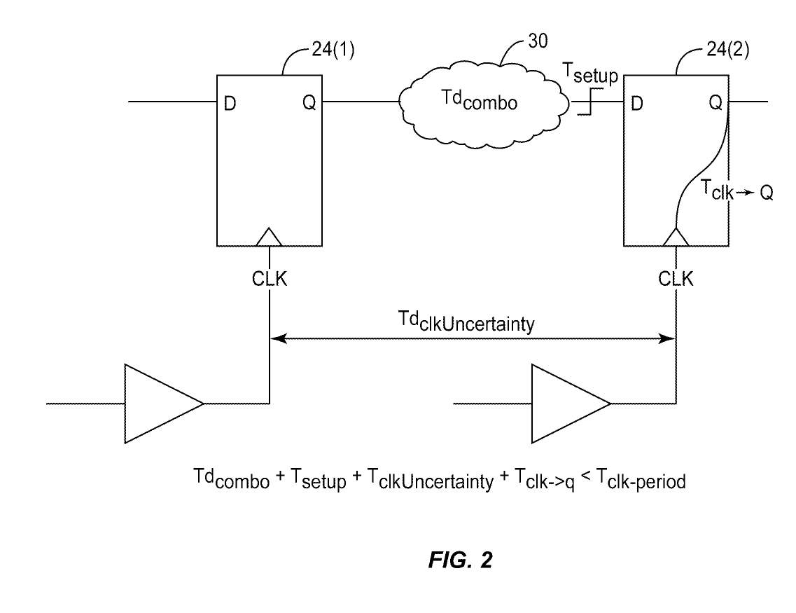

FIG. 2 provides a simplified schematic that summarizes the sources of delay between different elements 24 within a clock tree 10. That is, a CLK signal arrives at a first element 24(1) and a second element 24(2), which, in an exemplary aspect are both flip-flops. The data signal at the input (D) of the first flip-flop, element 24(1) will eventually pass through to the input (D) of the second flip-flop, element 24(2) through a combinatorial cloud 30. For this data to be captured correctly at the output (Q) of the second element 24(2), the data needs to arrive at the input (D) of the second element 24(2) within a setup time window. This arrival constraint generates the simple mathematical constraint of Td_{combo}+Tₛₑₜᵤₚ+T_{clkUncertainty}+T_{clk->Q}<T_{clk-period}; where Td_{combo} is the signal delay through the combinatorial cloud 30, Tₛₑₜᵤₚ is the flip-flop setup time of the second element 24(2), T_{clk->q} is the clock to Q delay of the second element 24(2) clock input to data output delay, and T_{clkUncertainty} is the uncertainty between the clock arrival time between the two elements 24(1) and 24(2).

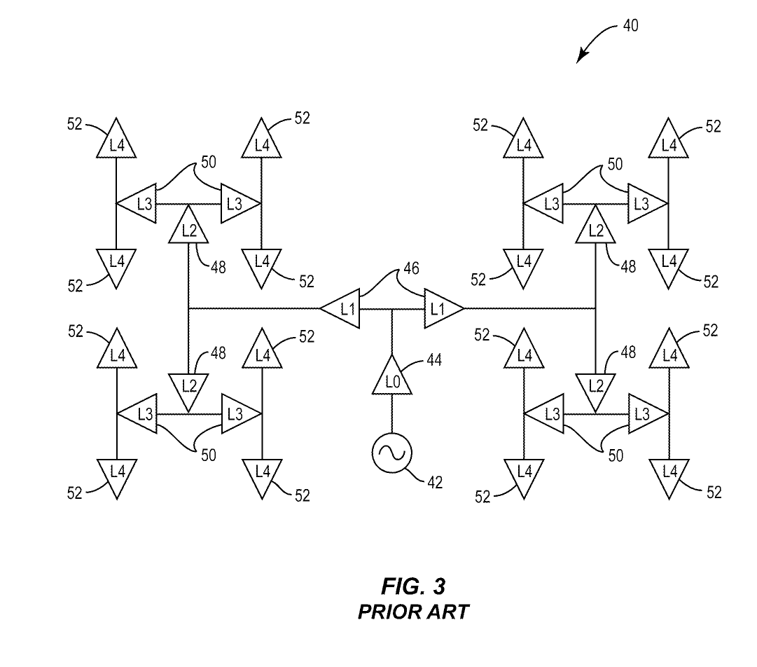

By way of further discussion, a conventional H-format clock tree 40 is presented in FIG. 3. The H-format clock tree 40 includes a clock source 42, and a source level (L0) clocked unit 44. The clock signal leaves L0 and splits evenly to two first generation (L1) clocked units 46. The clock signal leaves each L1 and splits evenly to two second generation (L2) clocked units 48. The clock signal leaves each L2 and splits evenly to two third generation (L3) clocked units 50. The clock signal leaves each L3 and splits evenly to two fourth generation (LA) clocked units 52 and so on. In each case, the clock signal splits evenly and may be conceptually viewed as an H shape. The H-format clock tree is useful in making sure that the physical distance and associated delay to a particular generation of clocked units is uniform. Such uniformity makes delay compensation easier. However, such mandated uniformity creates other circuit design issues as the circuits must be laid out and placed according to the strict requirements of the H-format. Allowing for asymmetric or random clock trees provides greater advantages and exemplary aspects of the present disclosure are particularly contemplated for clock trees that do not conform to an H-format.

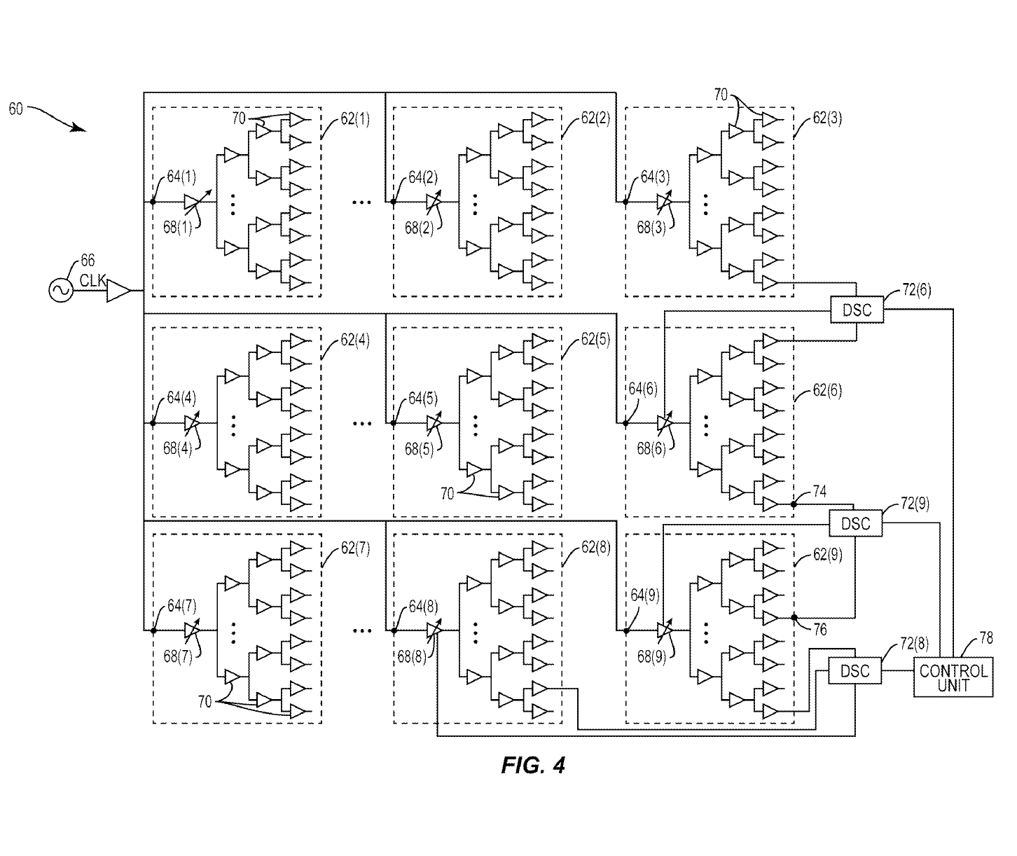

A first exemplary aspect of the clock skew management techniques of the present disclosure is provided with reference to FIG. 4. A clock tree 60 has branches or sub-units 62 (in this case sub-units 62(1)-62(9)), each of which has a clock signal provided to a respective root 64(1)-64(9) by a clock 66. The CLK signal passes from the respective root 64 to a respective PDC 68 (e.g., sub-unit 62(1) has root 64(1) and PDC 68(1)). The PDC 68 is configured to receive the clock signal and generate a delay output that corresponds to a delayed clock signal. The amount of delay is based on a control input as further described below.

With continued reference to FIG. 4, while the clocked elements 70 within each sub-unit 62 are shown as being symmetrical, it should be appreciated that the clocked elements 70 need not be symmetrical. As noted above, the clocked elements 70 may be flops or latches or other clocked elements as needed or desired. It should be appreciated that certain ones of the sub-units 62 are adjacent or otherwise physically proximate other ones of the sub-units 62. As illustrated, for example, sub-unit 62(6) is adjacent sub-unit 62(9) and sub-unit 62(9) is also adjacent sub-unit 62(8).

With continued reference to FIG. 4, a delay sense circuit (DSC) 72 is associated with adjacent or proximate sub-units 62. For example, DSC 72(8) is associated with the sub-units 62(8) and 62(9); a second DSC 72(9) is associated with the sub-units 62(9) and 62(6); a third DSC 72(6) is associated with the sub-units 62(6) and 62(3). Other DSCs (not illustrated) are associated with the remaining sub-units 62. In practice, each sub-unit 62 will have a respective DSC 72. The DSC 72 outputs a control input to the respective PDC 68. (E.g., DSC 72(9) outputs a control input for PDC 68(9)). The DSC 72 has a first delay input coupled to a delayed output from one of the associated adjacent sub-units 62 and a second delay input coupled to a delayed output from a second one of the associated adjacent sub-units 62. As used herein, the delayed output that is received by the DSC 72 is an output of the PDC 68, further delayed by elements 70 within the sub-unit 62. Thus, by way of illustration, node 74 of the sub-unit 62(6) is a first delay output generated by the PDC 68(6). Likewise, node 76 of the sub-unit 62(9) is a delay output generated by the PDC 68(9). The DSC 72 compares the arrival time between the delay output of the first associated adjacent sub-unit 62 with the delay output of the second associated adjacent sub-unit 62 and generates a correction signal. The correction signal is supplied to a global control unit 78.

With continued reference to FIG. 4, the global control unit 78 receives the correction signals from each of the DSC 72 and determines a global control input that is then sent to the DSC 72 with instructions on what control input the DSC 72 should provide to the PDC 68. In this manner, conflicts between sub-units 62 may be resolved. For example, if sub-unit 62(9) is faster than sub-unit 62(8) but slower than sub-unit 62(6), the global control input instructs the sub-unit 62(6) to generate sufficient delay in PDC 68(6) to match the delay in sub-unit 62(8), not just to match sub-unit 62(9).

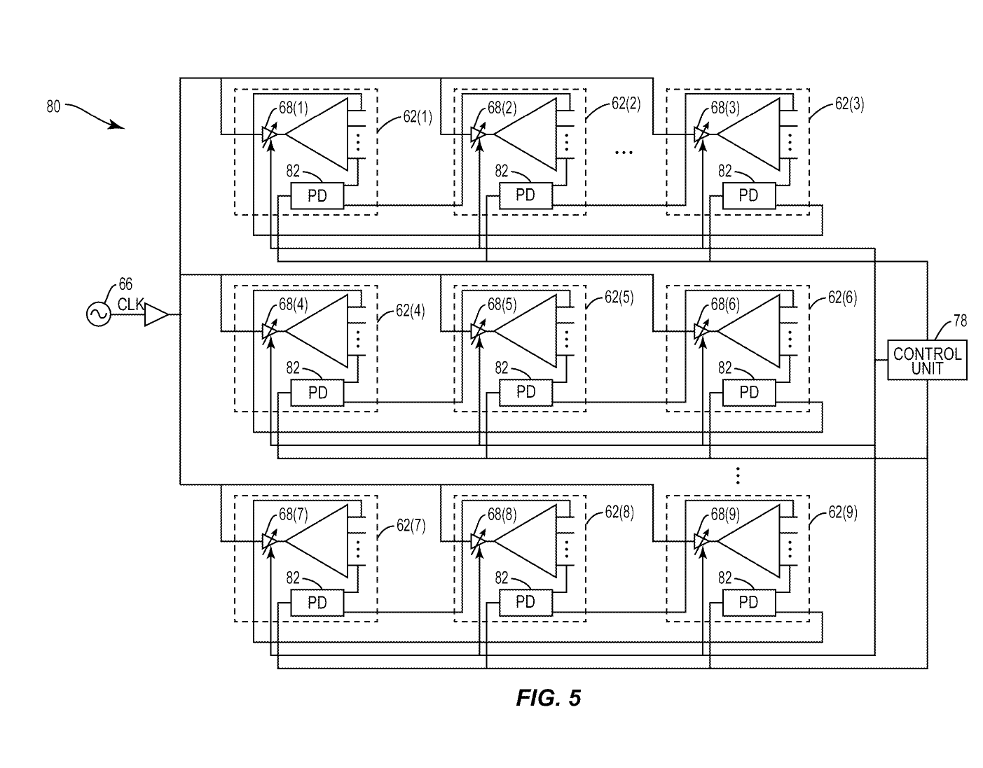

While the aspect of FIG. 4 is appropriate for many designs, circuit designers may need to have flexibility in how circuits are designed. Accordingly, additional aspects are presented herein which may help a circuit designer meet potentially different design criteria. For example, having additional intelligence in the DSC 72 may require a larger circuit footprint for the DSC 72 and consume too much space within the IC. In this regard, FIG. 5 illustrates an exemplary clock tree 80 where, instead of the DSC 72, a phase detector 82 may be used. Likewise, instead of the global control unit 78 instructing the DSC to instruct the PDC 68, the global control unit 78 instructs the PDC 68 directly. Because there is less circuitry involved in the phase detector 82 compared to the DSC 72, space may be conserved. The phase detector 82 may generate an error signal that is passed to the global control unit 78.

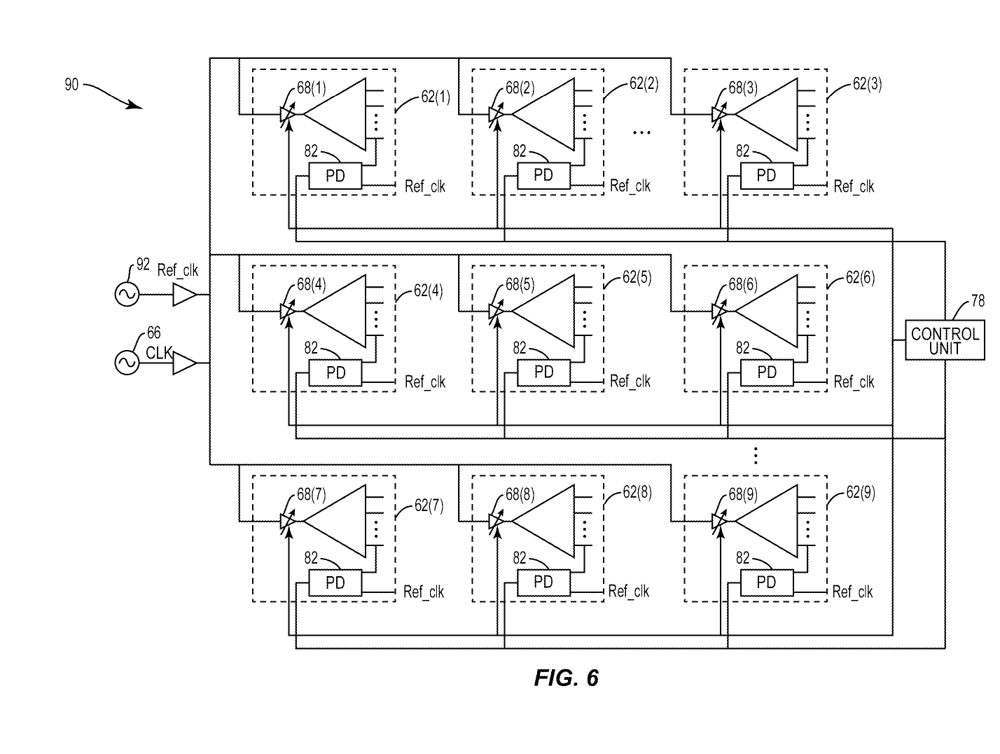

Clock tree 90 illustrated in FIG. 6 is similar to clock tree 80 of FIG. 5. However, instead of the phase detectors 82 comparing delayed outputs from adjacent associated sub-units 62 as is done in clock tree 80, in clock tree 90, the phase detectors 82 compare the delayed output from a single associated sub-unit 62 to a reference clock (ref-clk) signal generated by reference clock 92. In an exemplary aspect, the reference clock 92 is synchronized with the clock 66. In a further exemplary aspect, the reference clock is the clock 66, but the signal from the reference clock 92 is not delayed by intervening clocked elements (only by the resistance of the conductive element that conveys the reference clock signal to the phase detectors 82). The phase detectors 82 still report to the global control unit 78 with an error signal. The global control unit 78 in turn controls the PDC 68 of the sub-units 62.

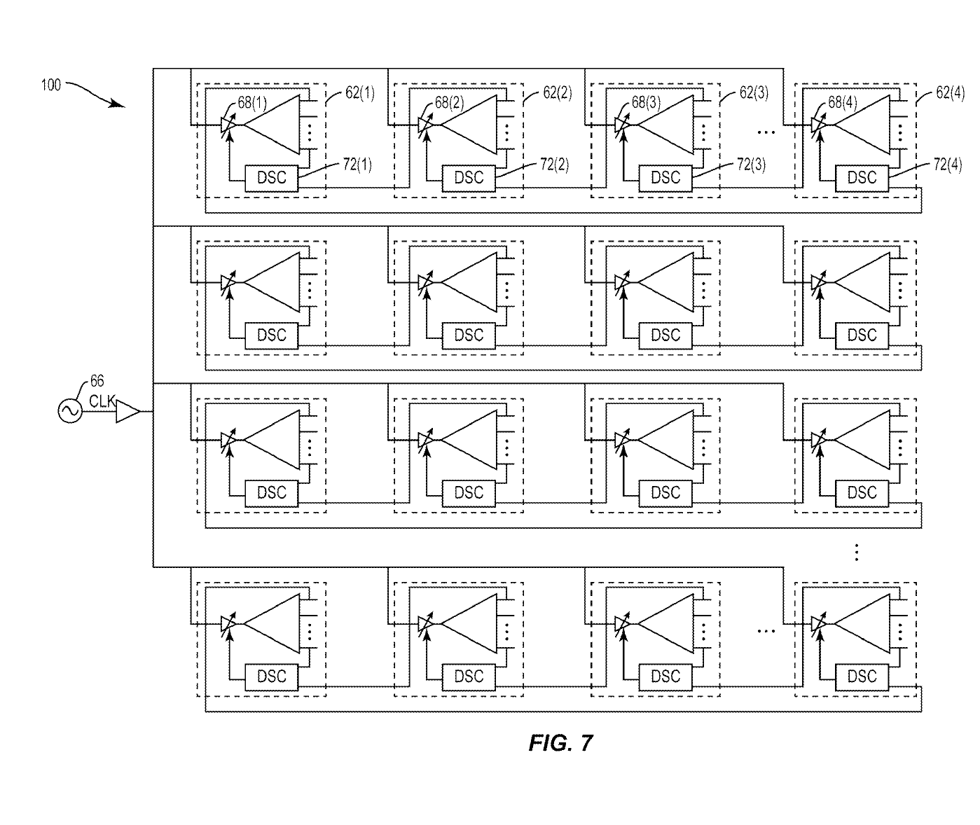

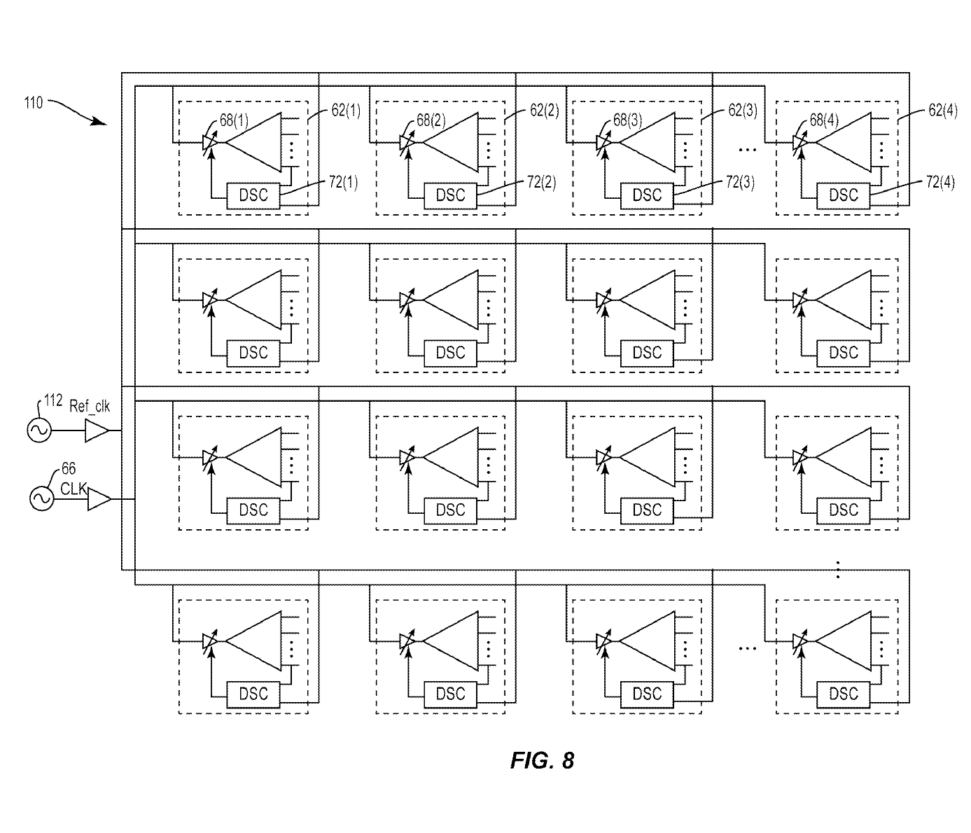

While the aspects of FIGS. 4-6 are useful for a variety of design criteria, the use of the global control unit 78 may consume too much space or otherwise not fit certain design criteria. Accordingly, the aspects of FIGS. 7 and 8 eliminate the need for the global control unit 78, albeit with other design tradeoffs.

In this regard, a clock tree 100 is illustrated in FIG. 7. In this aspect, the sub-units 62 are effectively daisy-chained together by the DSC 72. That is, for example, the DSC 72(1) may receive a first delay output from the first sub-unit 62(1) and a second delay output from the second sub-unit 62(2) while the DSC 72(2) receives the second delay output from the second sub-unit 62(2) and the third delay output from the third sub-unit 62(3) and so on. The DSC 72 then compares the two received delay outputs and generates a correction signal or control signal that is supplied to the corresponding PDC 68. While it is illustrated that the rows of sub-units 62 are daisy chained without passing between rows (e.g., sub-unit 62(4) is coupled to sub-unit 62(1)) it should be appreciated that the daisy chain may extend to other rows without departing from the scope of the present disclosure.

Clock tree 110 of FIG. 8 is similar to clock tree 100, but instead of daisy chaining the sub-units 62 together, a reference clock (ref-clk) signal from reference clock 112 is used for the comparison. Thus, the DSC 72 compares the received delay output to ref-clk and generates a control signal for the corresponding PDC 68.

For aspects using a reference clock (i.e., clock trees 90, 110), the reference clock tree is not loaded and overall clock skew within the reference clock should be relatively small. Further, the reference clock tree could be an H-format or mesh clock tree to further reduce skew. While the reference clock tree could be an H-format, the actual clocked elements 70 remain in an asymmetric or other non-H-format. While the clock tree tuning provided by the PDC 68 may be continuous, in other aspects, the clock tree tuning may be done: 1) once during production testing to compensate for process variations, 2) every time the device is powered up to compensate for process variations and aging, or 3) dynamically during operation (e.g., periodically, continuously, or after a certain number of predefined events) to compensate for process variations, aging, temperature changes, and Vdd changes. Note further that the reference clock tree may be shut down or otherwise gated when calibration is completed to conserve power. While the above discussion has generally assumed that the delayed output is uniform throughout a given sub-unit 62, if the sub-unit 62 has an asymmetrical design, a clocked element 70 within the sub-unit 62 may be selected as the output delay to represent an average clock delay compared to other leaf cells within the sub-unit 62.

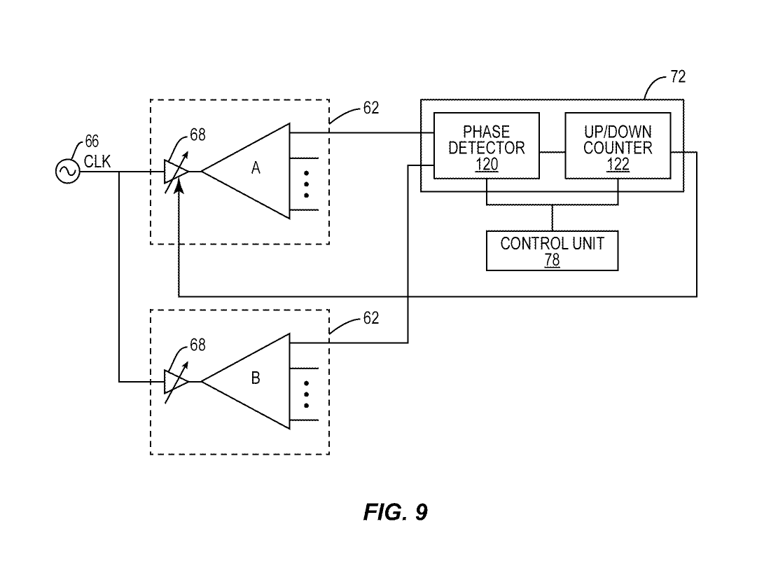

While DSC 72 may be implemented in a variety of ways, an exemplary structure for a DSC 72 is illustrated in FIG. 9. In particular, the DSC 72 includes a phase detector 120 and an up/down counter 122. The up/down counter 122 receives input from the phase detector 120 and from the global control unit 78. When the up/down counter 122 reaches a predefined threshold, the control signal is generated and sent to the PDC 68.

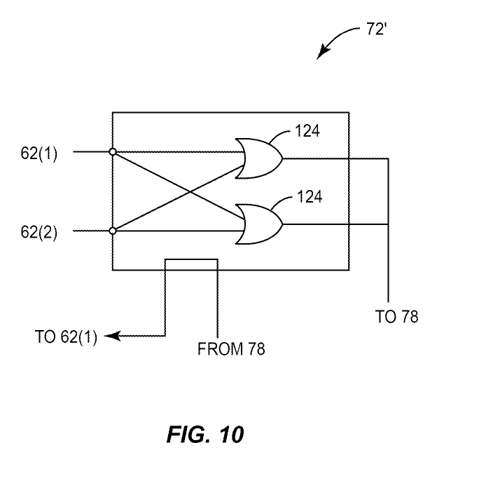

An alternate DSC 72′ is illustrated in FIG. 10. The DSC 72′ receives the delay outputs from the sub-units 62 at OR gates 124. The outputs of the OR gates 124 are passed to the global control unit 78, which in turn provides control signals back to the DSC 72 for use by the PDC 68.

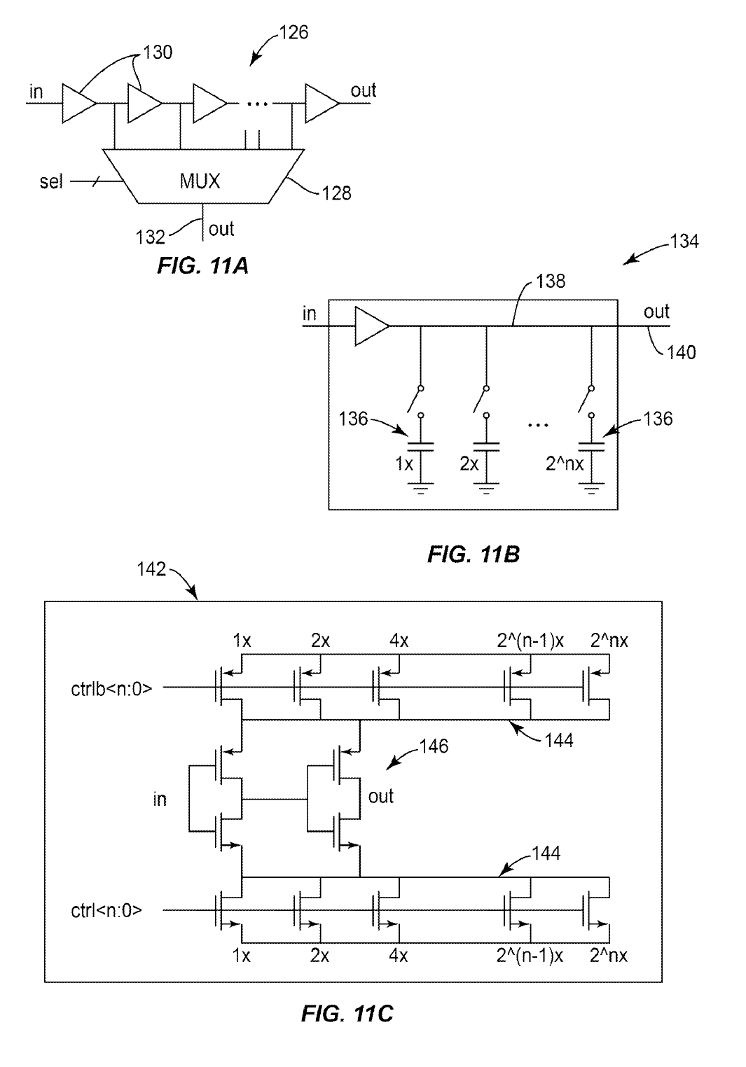

As with the various ways to implement a DSC 72, there are multiple ways to implement a PDC 68. However, FIGS. 11A-11C illustrate a few exemplary aspects. In this regard FIG. 11A illustrates a first coarse adjustment PDC 126 with a multiplexer (MUX) 128 receiving outputs from a plurality of clocked elements. The delayed signal at output 132 may be passed to the rest of the sub-unit 62. FIG. 11B illustrates a fine adjustment PDC 134, where capacitors 136 are selectively switched into the delay path 138 to provide a desired delay at output 140. Another fine adjustment PDC 142 is illustrated in FIG. 11C where field effect transistors 144 are controlled to give a desired delay at output 146.

The clock trees according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

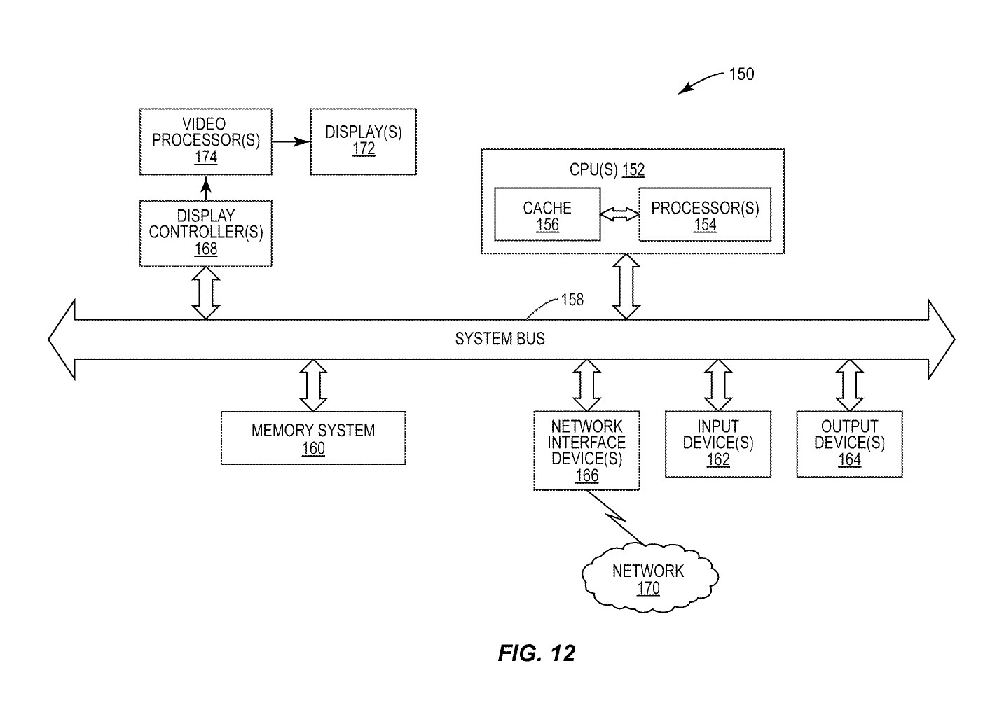

In this regard, FIG. 12 illustrates an example of a processor-based system 150 that can employ the clock tree management schemes illustrated in FIGS. 4-8. In this example, the processor-based system 150 includes one or more central processing units (CPUs) 152, each including one or more processors 154. The CPU(s) 152 may have cache memory 156 coupled to the processor(s) 154 for rapid access to temporarily stored data. The CPU(s) 152 is coupled to a system bus 158 and can intercouple devices included in the processor-based system 150. As is well known, the CPU(s) 152 communicates with these other devices by exchanging address, control, and data information over the system bus 158. For example, the CPU(s) 152 can communicate bus transaction requests to the memory system 160.

Other devices can be connected to the system bus 158. As illustrated in FIG. 6, these devices can include a memory system 160, one or more input devices 162, one or more output devices 164, one or more network interface devices 166, and one or more display controllers 168, as examples. The input device(s) 162 can include any type of input device, including but not limited to input keys, switches, voice processors, etc. The output device(s) 164 can include any type of output device, including but not limited to audio, video, other visual indicators, etc. The network interface device(s) 166 can be any devices configured to allow exchange of data to and from a network 170. The network 170 can be any type of network, including but not limited to a wired or wireless network, private or public network, a local area network (LAN), a wide local area network (WLAN), and the Internet. The network interface device(s) 136 can be configured to support any type of communication protocol desired.

The CPU(s) 152 may also be configured to access the display controller(s) 168 over the system bus 158 to control information sent to one or more displays 172. The display controller(s) 168 sends information to the display(s) 172 to be displayed via one or more video processors 174, which process the information to be displayed into a format suitable for the display(s) 172. The display(s) 172 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a DSP, an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A clock tree, comprising:
a first clock branch of the clock tree, the first clock branch comprising a first single programmable delay cell configured to receive a clock signal and generate a first delay output comprised of a first delayed clock signal based on a first control input;
a second clock branch of the clock tree, the second clock branch comprising a second single programmable delay cell configured to generate a second delay output comprised of a second delayed clock signal based on a second control input;
a third clock branch of the clock tree, the third clock branch comprising a third single programmable delay cell configured to generate a third delay output comprised of a third delayed clock signal based on a third control input;
a first delay sense circuit comprising a first delay input coupled to the first delay output and a second delay input coupled to the second delay output, the first delay sense circuit configured to generate a first correction signal based on the difference in time arrival between the first delay output and the second delay output;
a second delay sense circuit comprising a third delay input coupled to the second delay output and a fourth delay input coupled to the third delay output, the second delay sense circuit configured to generate a second correction signal based on the difference in time arrival between the second delay output and the third delay output; and
a global control unit configured to receive the first correction signal and the second correction signal and determine a global control input based on the correction signals, wherein the global control input determines the first control input, the second control input and the third control input.

2. The clock tree of claim 1, further comprising a clock configured to generate the clock signal.

3. The clock tree of claim 1, wherein the first clock branch of the clock tree comprises a plurality of clocked elements.

4. The clock tree of claim 3, wherein at least one of the plurality of clocked elements is selected from the group consisting of: a flop and a latch.

5. The clock tree of claim 1, wherein the first clock branch is physically proximate the second clock branch.

6. The clock tree of claim 1, wherein the global control unit is configured to send a control command based on the global control input to the first delay sense circuit and the first delay sense circuit sends the first correction signal to the first single programmable delay cell.

7. A clock tree, comprising:
at least one first clock branch of the clock tree, the at least one first clock branch comprising a first phase detector and a first single programmable delay cell configured to receive a clock signal and generate a first delay output comprised of a first delayed clock signal based on a first control input, the first phase detector receiving the first delayed clock signal and a second delayed clock signal from at least one second clock branch and generate a first error signal;
the at least one second clock branch of the clock tree, the at least one second clock branch comprising a second phase detector and a second single programmable delay cell configured to generate a second delay output comprised of a second delayed clock signal based on a second control input, the second phase detector receiving the second delayed clock signal and a third delayed clock signal from at least a third clock branch and generate a second error signal, and
a global control unit configured to receive the first and second error signals and generate the first and second control inputs.

8. The clock tree of claim 7, further comprising a clock configured to generate the clock signal.

9. The clock tree of claim 7, wherein the first clock branch of the clock tree comprises a plurality of clocked elements.

10. The clock tree of claim 9, wherein at least one of the plurality of clocked elements is selected from the group consisting of: a flop and a latch.

11. The clock tree of claim 7, wherein the first clock branch is physically proximate the second clock branch.

12. The clock tree of claim 7, wherein the first single programmable delay cell comprises a coarse adjustment module and a fine adjustment module.

13. A clock tree, comprising:
at least one first clock branch of the clock tree, the at least one first clock branch comprising a first phase detector and a first single programmable delay cell configured to receive a clock signal and generate a first delay output comprised of a first delayed clock signal based on a first control input, the first phase detector receiving the first delayed clock signal and a global clock signal and generate a first error signal;
at least one second clock branch of the clock tree, the at least one second clock branch comprising a second phase detector and a second single programmable delay cell configured to generate a second delay output comprised of a second delayed clock signal based on a second control input, the second phase detector receiving the second delayed clock signal and the global clock signal and generate a second error signal, and
a global control unit configured to receive the first and second error signals and generate the first and second control inputs.

14. The clock tree of claim 13, further comprising a clock configured to generate the clock signal.

15. The clock tree of claim 13, wherein the first clock branch of the clock tree comprises a plurality of clocked elements.

16. The clock tree of claim 15, wherein at least one of the plurality of clocked elements is selected from the group consisting of: a flop and a latch.

17. The clock tree of claim 13, wherein the global clock signal is parallel to the clock signal.

18. The clock tree of claim 13, wherein the first single programmable delay cell comprises a coarse adjustment module and a fine adjustment module.

19. The clock tree of claim 13 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

20. A method of operating a clock tree within an integrated circuit (IC), the method comprising:
generating a clock signal at a root;
directing the clock signal through a first clock branch of the clock tree, wherein the first clock branch is not an H-format clock branch;
directing the clock signal through a second clock branch of the clock tree;
receiving delayed clock signals from the first clock branch and the second clock branch at a delay sense circuit;
calculating at the delay sense circuit a difference in arrival times of the delayed clock signals from the first clock branch and the second clock branch;
providing an indication of the difference in arrival times to a global control unit;
generating at the global control unit a control input based on difference in arrival times of the delayed clock signals;
providing the control input to the delay sense circuit; and
sending a correction signal to a first programmable delay cell in the first clock branch.
